(19) United States
(12) Patent Application Publication
(10) Pub. No.: US 2003/0125997 A1
(43) Pub. Date: Jul. 3, 2003

(54) System and method for risk assessment

(76) Inventor: Allison Stoltz, Midlothian, VA (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/022,438

(22) Filed: Dec. 20, 2001

(51) Int. Cl. G06F 17/60

(52) U.S. Cl. 705/7

(57) ABSTRACT

A system and method for use in compliance management is provided. The system comprises a query module associated with an engine for presenting at least one user with a series of questions relating to at least one business category, and for soliciting and receiving responses from the at least one user for each question presented. The system also includes a prioritization module associated with the engine for prioritizing the at least one business category based on the at least one user's responses and at least one standard severity risk index. Also provided is an administration module associated with the engine for inputting, updating and accessing data associated with the query, and prioritization modules, the administration module being accessible to an administrator of the system via an administration interface.

### BACKGROUND OF THE INVENTION

The present invention relates to a system and method for use in compliance management, and more specifically to a system and method for assessing business risk through the use of a severity rubric.

Entities doing business in regulated industries must comply with a multitude of federal, state and local laws and regulations. The insurance industry is no exception. For example, each insurer must comply with various federal regulations, and must hold a certificate of authority in each state in which it operates. Moreover, an agent of the insurer must be licensed with each state, and must be appointed by the insurer to act as the insurer's agent. Further complicating matters, each state may have a plurality of different regulatory requirements regarding disclosure of information to potential and existing customers (or policyholders), an amount of liquidity the insurer must maintain, and other regulations regarding activities of the insurer. Also, many states have an “Unfair Claims Practice Act” mandating compliance with certain standards of insurer conduct. Other states may define similar regulations under an “Unfair Insurance Practices Act”, an “Unfair Claims Settlement Practices Act”, or other similar statute. Furthermore, different insurance products may be subject to different regulatory requirements.

As another example, most states have enacted one or more statutes that require that an insurer settle a policyholder's claim within a reasonable time. These statutes also require the insurer to respond to a written request from a policyholder for claims forms and other information. Under most Unfair Claims Settlement Practices Acts and similar state statutes, an insurer may not knowingly misrepresent material facts or relevant policy provisions in connection with a policyholder's claim. Also, the insurer must acknowledge the filing of a policyholder's claim and act promptly in response to the filed claim. Some states institute a mandatory time period within which the insurer must respond to a filed claim, such as within a 15 day period. In accordance with such state statutes, the insurer must implement a plurality of standard practices for promptly investigating and processing a policyholder's claim. Otherwise, the insurer could assert that it is continuing investigation of a filed claim indefinitely, thereby effectively denying relief to a policyholder. Furthermore, the insurer may not delay an investigation or a settlement of a filed claim by requiring unnecessary or repetitive forms and proofs from the policyholder. Also, the insurer may not refuse to pay a filed claim or deny payment under a filed claim without a valid reason and an explanation for such a denial. Many states also provide for penalties in the event that the insurer fails to meet the states' specific statutory requirements. And, as set forth above, many insurers serve policyholders in different states and regions where regulations and statutes may differ.

As another illustrative example, with respect to automotive warranty services products, each state has a plurality of specific regulations that protect a consumer against a plurality of unfair claims settlement practices, such as slow or deceptive claims handling. Furthermore, every state has a plurality of laws that prohibit unfair, discriminatory, or deceptive practices. While one level of compliance may be acceptable in one state, the same level of compliance may be deficient in another state.

In addition to ensuring compliance with a plurality of mandatory state and federal regulatory requirements, an entity may voluntarily impose upon itself a plurality of higher standards than such mandatory statutory and regulatory requirements in order to provide better customer service and improve its customer relations and to differentiate itself from its competitors. The entity may therefore have a need to track its compliance with the mandatory regulatory and statutory requirements and with the voluntary higher standards. Therefore, it becomes necessary for the entity to implement a system to manage its compliance with the various different federal, state, and interval statutory and regulatory requirements.

Therefore, insurers who offer a plurality of insurance products in a plurality of states may suffer from the difficulty and expense of ensuring compliance with a number of different regulatory requirements. Accordingly, it is difficult for an entity doing business in a heavily-regulated industry to maintain compliance where there are many different regulatory and statutory requirements with which the entity must comply.

Typically, companies conduct annual surveys that assist the company in assessing the risk severity associated with non-compliance of particular laws, rules, or regulations. For instance, a company may require its departments or units to answer several questions that focus on specific risk areas. Examples of such laws and regulations include equal employment, privacy issues, outsourcing requirements, etc. Moreover, the departments or units are typically asked to assess and rate the severity of non-compliance within each business area or category being surveyed.

One problem with this approach, however, concerns the lack of a uniform and standard approach for assessing risk. For example, one department may rate the severity of non-compliance with a particular regulation as being of low risk, while another department may rate the same non-compliance as being of high and urgent risk. This problem is particularly onerous because it tends to undermine the purpose of the survey, which is to identify the most severe or high risk areas. Further, there is no known system or method for efficiently and accurately measuring and gauging risk severity via company-wide surveys and/or questionnaires. Present systems and methods for methods measuring risk are cumbersome and difficult to rate.

These and other problems exist.

### BRIEF SUMMARY OF THE INVENTION

An object of the present invention is to overcome the aforementioned and other drawbacks existing in prior art systems and methods.

Another object of the present invention is to provide a system and method for identifying regulatory and statutory compliance issues associated with various business practices.

Another object of the invention is to provide a system and method for measuring and assessing risk associated with regulatory and statutory compliance issues.

Another object of the invention is to utilize a standard severity risk rubric to measure and assess risk associated with regulatory and statutory compliance issues.

Another object of the invention is to provide a uniform measure of risk assessment to enable companies to identify risk trends.

Additional objects and advantages of the invention will be set forth in part in the description which follows, and in part will be obvious from the description, or may be learned by practice of the invention. The objects and advantages of the invention may be realized and attained by means of the instrumentalities and combinations particularly pointed out in the appended claims.

To achieve the objects, and in accordance with the purposes of the invention, as embodied and broadly described herein, this invention, in one aspect, includes a method for use in compliance management. Specifically, according to the inventive method, at least one user is presented, via a computer, with a series of questions relating to at least one business category. Next, responses are solicited from the at least one user, via the computer, for each question presented. Lastly, the at least one business category are prioritized, via the computer, based on the at least one user's responses and at least one standard severity risk index.

In another aspect, the invention includes a system for use in compliance management. Specifically, the system includes a query module associated with an engine for presenting at least one user with a series of questions relating to at least one business category, and for soliciting and receiving responses from the at least one user for each question presented. The system also includes a prioritization module associated with the engine for prioritizing the at least one business category based on the at least one user's responses and at least one standard severity risk index.

The accompanying drawings, which are incorporated in and constitute a part of this specification, illustrate various embodiments of the invention and, together with the description, serve to explain the principles of the invention.

### BRIEF DESCRIPTION OF THE DRAWINGS

FIG. 1 is a flow chart process for prioritizing business area risk according to an embodiment of the invention.

FIG. 2 is a flow chart process further detailing the prioritization step of FIG. 1 according to an embodiment of the invention.

FIG. 3 is a schematic representation of a system for use in compliance management according to an embodiment of the invention.

FIG. 4 is a schematic representation of the server station of FIG. 2 according to an embodiment of the invention.

### DETAILED DESCRIPTION OF THE INVENTION

Reference will now be made to the present preferred embodiment of the invention, an example of which is illustrated in the accompanying drawings in which like reference characters refer to corresponding elements.

The present invention is described in relation to a system and method for measuring risk associated with regulatory and statutory compliance issues. Nonetheless, the characteristics and parameters pertaining to the system and method may be applicable to measuring risk associated with other types of issues and/or content.

As described herein, the system and method of the invention may generally be used in compliance management, particularly as it relates to measuring and assessing business area risk associated with noncompliance of various regulations, including federal, state and internal rules and laws. According to one embodiment, the system and method of the invention may be used to conduct a survey concerning compliance of laws and regulations by specific corporate departments or units. In one example, a regulated company may provide a method for soliciting responses from individual departments or units to questions or queries presented to them relating to compliance issues within designated business areas. Examples of typical business areas may include but are not limited to: Infrastructure; Product Development; Sales and Marketing; Servicing; Equal Employment Opportunity; Health, Safety; and Environmental Protection; Ethical Business Practices; Compliance with Antitrust Laws; Financial Controls and Records; etc. The survey questions may be general and broad, or may be specific and detailed.

According to the invention, a total risk severity score is determined based, among other things, on the department or unit responses, the potential consequences, and the expected severity of non-compliance. For example, in one embodiment, a detection index may be determined based on user responses, the number of users participating, and the number of questions presented. An occurrence index may also be determined based on the potential consequences of non-compliance. Lastly, an expected severity risk index is determined based on the expected risk severity associated with non-compliance. The total risk score may then be determined and is equivalent to the product of the detection, occurrence, and risk severity indices. The resulting total risk score may then be used to rank the business areas and categories based on risk severity. Specifically, the higher the total risk score, the higher the severity risk of non-compliance. The company may then use this information to develop and implement remedial measures in an efficient and accurate fashion.

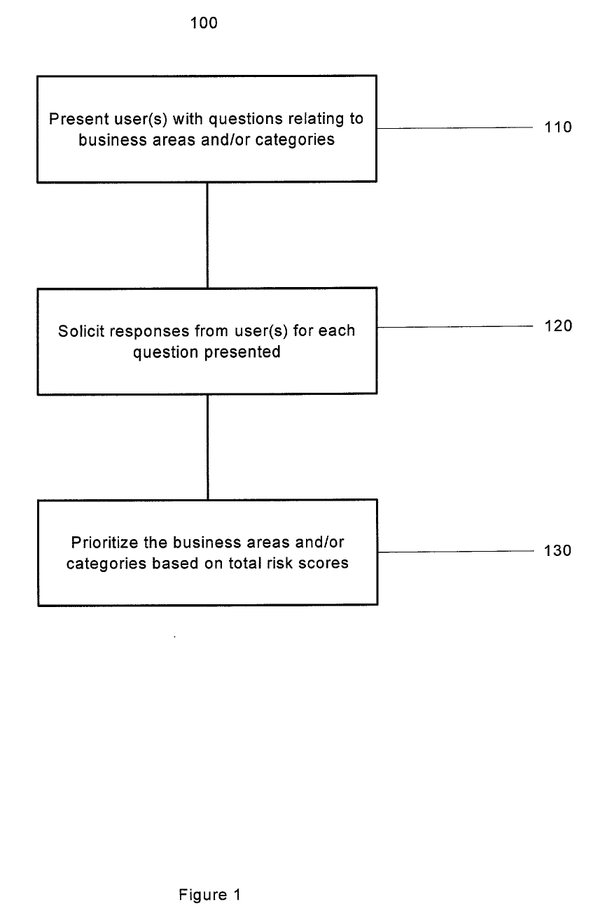

FIG. 1 illustrates one embodiment of the method of the invention. The method 100 shown may be used in compliance management, such as measuring and assessing business area risk based on the unit or department responses to questions presented. As shown, the process 100 is initiated at step 110, wherein questions are presented to a user (i.e., corporate department or unit) regarding compliance issues relevant to one or more business areas and/or categories. In a regulated industry, for example, a particular unit or department, e.g. a compliance office, may be responsible for ensuring—or at least measuring or gauging—the level of compliance within the company and its departments and units. In this case, the compliance office may design a survey containing questions designed to inquire about particular issues that may arise within specified business areas. For instance, a group of questions may be designed to inquire about the area of Product Development. Further, the questions may be classified to inquire about specific categories within the area of Product Development, such as, for example, product design, e-business, and state product filings. The following is an example:

Product Development

A. Product Design

1. Is your business using the ABCD process to develop new products including minor and major enhancements and are all appropriate functions included in the process.

2. Does the ABCD process have an owner and is it monitored?

3. Does the company have a written process for legal/compliance review by an appropriate party of all new product documentation (policy forms, application forms, attachments, etc.)

B. e-Business

4. Is your business using the e-ABCD process to develop new products including minor and major enhancements?

5. Does the e-ABCD process for e-ABCD have an owner and is it monitored?

6. Is there a formal process to monitor the activity of our producers (agents/distributors) who provide quote services that impact the company's products in the e-Business environment?

C. State Product Filings

7. Does the company have a documented process to ensure all products are appropriately filed with the applicable states, including minor and major enhancements?

8. Does the documented process to ensure all products are appropriately filed with the applicable states have an owner and is it monitored routinely?

9. Does the company have a documented process to ensure all actuarial data and risk management activities are performed regularly and filed as required.

10. In the past three fiscal years did all state exams or inquiries indicate that no policy or application forms need to be filed as a result of the exam?

As drafted, the above questions inquire about specific issues within categories of the Product Development area. For example, questions 1-3 relate to the category product design and thus inquire about compliance issues within the product design function of the company and/or department. The ABCD process mentioned in questions 1 and 2 may be any process which is either preferred by the company, or which is required by law or regulation. Question 3 inquires about monitoring compliance by the company's agents. Questions 4-6 are similar to 1-3, but relate to the category of e-business within the area of Product Development. Questions 7-10 relate to state product filings and thus inquire about compliance with various state laws or regulations. Similar questions may be developed for other categories within Product Development, as well as other business areas. The specific issues targeted by the questions may of course vary depending on the nature of the industry and other considerations.

Next, at step 120, responses to the survey questions are solicited from the corporate departments or units. In one embodiment, the responses may be solicited through a computer, such as by transmitting to the department a spreadsheet file listing the individual questions and providing an answer/response area for each question. In this example, the department or unit may review the questions and record its response. In another embodiment, responses are solicited via a graphical user interface (GUI) that may be accessed by a department or unit over a communications network, such as the Internet. The GUI presents the questions and provides the appropriate areas to the department or unit to provide responses.

According to one embodiment, responses to the questions are limited to “Yes” or “No” answers, which may be indicated by entering a “1” or “2,” respectively, in the appropriate area. According to another embodiment, responses include a “Yes” or “No” answer, followed by an explanation or elaboration. For example, a department or unit representative responding to the questions may receive a series of questions, such as those listed above relating to Product Development, and proceed to review and answer the questions. According to one embodiment, each question presented is associated with at least one area where a response may be recorded. For instance, a question may provide two response boxes, one designating a “No” response, and the other a “Yes” response. Further, a third box may be provided where the representative may provide further detail, such as an explanation or elaboration. In another embodiment, the department or unit may designate “N/A” (Not Applicable) in response to a question, which may be indicated by inputting a “Ø”.

According to yet another embodiment, “Yes” and “No” responses can be further classified to provide for more specific or detailed responses. In such an embodiment, for example, responses may be provided according to the following scale:

Responses

0- Not applicable

1- Yes, no further work is needed

2- Yes, some improvement is needed to get to the level the Compliance office wants it to be

3- No, almost to yes

4- No, sometimes

5- No, seldom or never

According to this embodiment, a department responding to question 1 of the Product Development set discussed above may provide a specific response as opposed to a general “Yes” or “No” answer. For instance, if the department has been working on implementing the ABCD process, but is not yet ready, then responding with #3 from the above scale would be a more accurate response than if a mere “No” was provided. Similarly, if the department continually uses the ABCD process, then the more appropriate response would be #1, indicating complete compliance by the department or unit. Other scales may of course be provided.

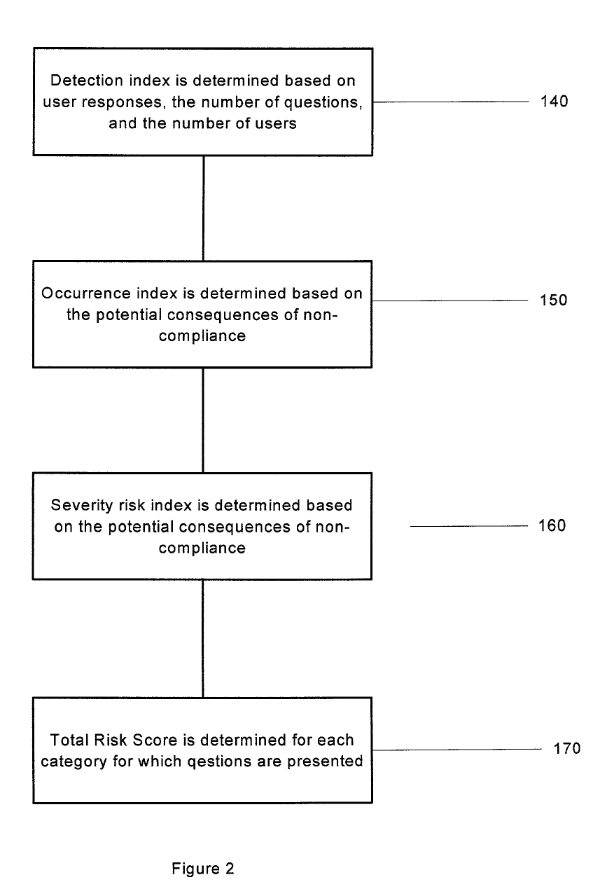

Next, once the questions have been properly answered by the participating departments or units, at step 130, the process initiates prioritization of the various business areas. The prioritization process of step 130 is shown in more detail in FIG. 2. According to one embodiment, the prioritization process involves determining a total risk score equal to the product of three indicators: a detection index, an occurrence index, and a severity risk index. The higher the total risk score, the more severe the risk of non-compliance. In one embodiment, the detection index weighs the total risk score based, among other things, on the responses provided to the individual questions; the occurrence index weighs the total risk score based on the potential consequences of non-compliance; and the severity risk index weighs the total risk score based on the expected severity of non-compliance. In one embodiment, each category surveyed is associated with particular detection, occurrence, and severity risk indices.

As shown in FIG. 2, at Step 140, a detection index is determined. In one embodiment, the detection figure may be determined according to the following algorithm:

$$Detection = \frac{{\sum }_{i = 1}^{n} i ( \# of {answers}_{i} )}{n}$$

In this embodiment, each possible outcome, i.e., response, as represented in the above equation by the variable “i”, is multiplied by the number of questions that were answered with that particular response, as represented by the variable “# of answers_{i.}” In other words, how many questions were answered with answer choice #1, how many with answer choice #2, how many were answered with answer choice #3, etc. The individual products are then added together and divided by “n,” the total number of questions in that category. In one embodiment, a detection index is determined for each category of business area, e.g., by product design, e-business, and state product filings. For example, continuing with the product design example discussed above, assume that a department or unit responded as follows:

| Question | Response |
|---|---|
| 1 | 1 |
| 2 | 2 |
| 3 | 4 |

The detection figure would be:

$$Detection = \frac{1 ( 1 ) + 2 ( 1 ) + 3 ( 0 ) + 4 ( 1 )}{3} = \frac{7}{3} = 2.33$$

If, however, the department responded as follows:

| Question | Response |
|---|---|
| 1 | 1 |
| 2 | 1 |
| 3 | 1 |

Then, the detection figure would be:

$$Detection = \frac{1 ( 3 )}{3} = 1.0$$

In another embodiment, the responses of more than one department may be used to determine a detection index. However, in this case the formula would be as follows (“d” equals the number of departments or units responding):

$$Detection = \frac{{\sum }_{i = 1}^{n} i ( \# of {answers}_{i} )}{( d ) ( n )}$$

Therefore, assume two departments respond as follows:

| Question | Department #1 Response | Department #2 Response |
|---|---|---|
| 1 | 1 | 4 |
| 2 | 1 | 4 |
| 3 | 1 | 4 |

In this case, the detection index would be:

$$Detection = \frac{1 ( 3 ) + 4 ( 3 )}{2 ( 3 )} = \frac{15}{6} = 2.5$$

In another embodiment, two departments may consider the survey questions presented and reach an agreement as to how each question should be responded. Accordingly, only one set of responses will be provided reflecting the their agreed to answers. In such a case, the above detection formula may used and “d” would be equal to “1.”

As may be appreciated from the above examples, the more “No” (or close to “No”) responses provided, the higher the resulting detector index. Other algorithms may be used to determine the detector index.

Next, at step 150, an occurrence index is determined. The occurrence index weighs the total risk score based on the potential consequences of noncompliance. According to one embodiment, the occurrence index is based on the total number of agents and/or employees affected by non-compliance. In another embodiment, the occurrence index is based on the total number of contracts or policies in force. That is, the higher the occurrence index, for example, the higher the total risk score because of the larger number of agents, employees, policies, or contracts that would be affected by non-compliance. Other occurrence indices contemplated by the invention may include but are not limited to: the total number of claims per year, and the number of contracts or policies issued within the last 12 months. In yet another embodiment, different occurrence indices may be used depending on the particular question being presented. The following is an example of an occurrence scale contemplated by the invention:

| Occurrence Index: | 0 | 1 | 2 | 3 |
|---|---|---|---|---|
| Total # of agents and/or | N/A | <10,001 | 10,000-100,001 | >100,001 |
| employees | | | | |
| # of policies in force | N/A | <500,00 | 500,00-2 M | >2 M |
| # of policies issued | N/A | <50,000 | 50,000-200,000 | >200,000 |
| in past 12 months | | | | |

According to the above chart, if a particular category is related to the total number of agents and/or employees, then a department or unit would designate “0” if the index is not applicable to the question, “1” if there are less than 10,001 agents, “2” if there are between 10,001 and 100,001 agents, and “3” if there are more than 100,001 agents. According to one embodiment, there is an occurrence index for each category within a business area. For example, the above Product Development area would have a total of three occurrence figures, one for each of the categories within Product Development, i.e., product design, e-business, and state product and filings. In one embodiment, the occurrence number is determined by the compliance office, or by the individual or unit responsible for conducting the survey of questions. In another embodiment, the occurrence index is chosen by the department or unit responding to the questions.

Next, at step 160, a severity risk index is selected. The severity risk index weighs the total risk score based on the expected risk of non-compliance. According to one embodiment, a severity risk index is selected for each category of questions within a business area, i.e., product design, e-business, and state product filings. According to another embodiment, the compliance office determines the severity risk index. For example, regarding the above questions relating to Product Development, once the compliance office receives a particular department or unit's response, it proceeds to determine a severity risk index for each of the three categories. In yet another embodiment, the severity risk index may be determined before responses are received from the departments or units. According to another embodiment, there may be two types of severity risk indicators: one relating to external categories and another to internal categories. External categories may include but are not limited to categories where compliance is partially based on external factors. Internal categories may include but are not limited to categories where compliance is partially based on internal factors. What classifies an external or internal category may be determined by the compliance office in keeping with the company's organizational structure and functions. The following are examples of severity queries considered by the compliance office in selecting a severity risk index for each category of questions presented:

External—How severe an impact would be placed on the business (e.g. external exposure, regulatory risk, litigation exposure) if processes/actions around the topic in question (1) did not exist, or (2) did not occur as they should.

Internal—How severe an impact would be placed on internal functions if processes/actions around the topic in question (1) did not exist, or (2) did not occur as they should?

In one embodiment, the compliance offices may respond to the above queries by selecting or indicating the expected severity risk associated with non-compliance. In one embodiment, the response to the query may be selected from a range of numbers comprising a predetermined severity rubric, each number representing a specific level of risk severity. For instance, the following is an example of standard severity risk rubric contemplated by the invention:

External Standard Severity Rubric

1- No Impact

2- Minor impact on external functions, issues easily corrected

3- Occasional impact on external functions (every 6-8 months)

4- Occasional impact on external functions (every 3-6 months)

5- Cross roads—problems could follow, could pose business risk

6- Challenge reliability/value of product/business

7- Create loss of trust in product/business, loss of customer trust

8- Would create serious concern from Senior leadership/Regulators

9- Threatens stability of business, creates loss of market share

10- Most severe impact, loss of license, cease and desist, failure of paper test

Internal Standard Severity Rubric

1- No impact

2- Minor impact on business, any issues easily corrected

3- Occasional impact on internal functions (every 6-8 months), issues easily corrected

4- Occasional impact in internal functions (every 3-6 months), issues corrected with relative ease

5- Cross roads—Complaints trend up, problems could follow, could pose risk

6- Negative impact on internal functions (monthly), issues fairly difficult to correct

7- Frequent negative impact on internal functions (monthly), issues fairly difficult to correct

8- Would create serious concern from Senior leadership

9- Threaten stability of business/internal functions

10- Most severe, continuous impact (daily), great potential to cause external exposure issues

Following selection of severity risk indices for each of the categories surveyed, at step 170, a total risk score is calculated for each category of questions presented indicating the level of severity. According to one embodiment, the total risk score for each category is determined by calculating the product of the detection, occurrence, and severity risk indices. In this embodiment, the higher the total risk score, the higher the level of risk severity.

To summarize the method of the invention, an example is provided. Assume 110 two business units, Business Unit #1 and Business Unit #2, are being surveyed regarding the area of Product Development. As part of the survey, each unit receives the above questions relating to categories of product design (questions 1-3), e-business (questions 4-6), and state product filings (questions 7-10). In response, the units answer as follows:

| Question # | Business Unit #1 | Business Unit #2 |
|---|---|---|
| 1 | 1 | 3 |
| 2 | 2 | 2 |
| 3 | 5 | 2 |
| 4 | 4 | 4 |
| 5 | 2 | 1 |
| 6 | 2 | 5 |
| 7 | 1 | 1 |
| 8 | 3 | 3 |
| 9 | 2 | 3 |
| 10 | 1 | 4 |

Based on these responses, the detection index for product design (i.e., questions 1-3) would be:

$$Detection = \frac{1 ( 1 ) + 2 ( 2 ) + 4 ( 2 ) + 5 ( 1 )}{( 2 ) ( 3 )} = \frac{15}{6} = 2.5$$

For e-Business (i.e., questions 4-6):

$$Detection = \frac{1 ( 1 ) + 2 ( 2 ) + 4 ( 2 ) + 5 ( 1 )}{( 2 ) ( 3 )} = \frac{18}{6} = 3.0$$

For state product filings (i.e., questions 7-10):

$$Detection = \frac{1 ( 1 ) + 2 ( 1 ) + 3 ( 3 ) + 4 ( 1 )}{( 2 ) ( 4 )} = \frac{16}{8} = 2.0$$

Next, an occurrence index is selected for each category using the occurrence indices described above. The compliance office selects as follows:

| Category | Occurrence Index |
|---|---|
| Product Design | 2 |
| e-Business | 3 |
| State Product Filings | 2 |

Next, a severity risk index for each category is selected. Assuming all the categories for which questions were presented relate to external issues, the compliance office responds to the above external question as follows:

| Category | Severity Risk Index |
|---|---|
| Product Design | 3 |
| e-Business | 2 |
| State Product Filings | 1 |

Based on the above indices, a total risk score can then be determined for each of the categories, as follows:

Product Design Risk Score=(2.5)(2.0)(2.0)=10.0

e-business Risk Score=(3)(3)(1)=18.0

State Product Filings=(2)(2)(1)=4.0

Based on these numbers, the method of the invention indicates the category of e-Business has a higher risk severity than the other two categories. Using this information, the compliance office can better allocate its resources to improve compliance scores in subsequent or follow-up surveys.

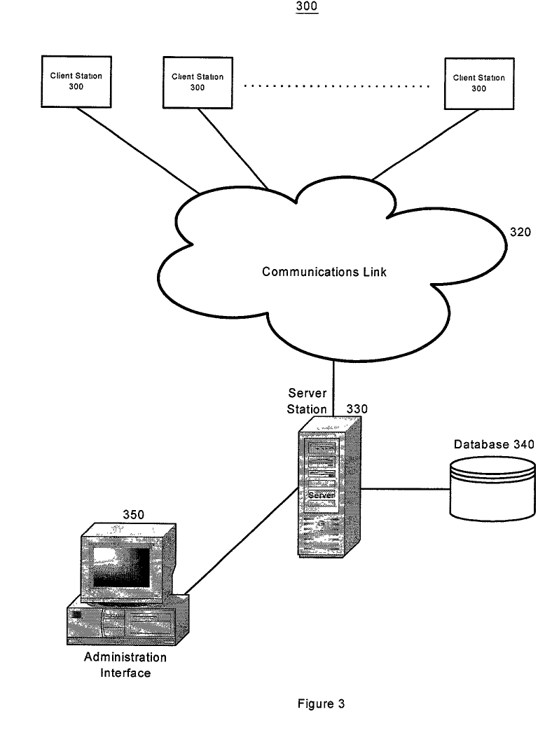

FIG. 3 illustrates one embodiment of a system 300 that may be used to perform the method of FIGS. 1 and 2. As shown, the system 300 may include a plurality of client stations 310 that may be accessed by representatives of the individual departments or units to answer a survey or a series of questions relating to compliance of laws or regulations of various business areas and categories. The survey or series of questions may be prepared and administered by a compliance office, for example. In one embodiment, each client station 310 may be located at the corresponding department or unit. In another embodiment, a client station 310 may be portable to provide maximum accessibility to the survey or series of questions. In such an embodiment, the representative answering the survey or questions has the added flexibility of moving around the department or unit to interact with individuals having more direct knowledge of the relevant compliance issues.

Client stations 310 may include, for instance, a personal or laptop computer running a Microsoft Windows™ 95 operating system, a Windows™ 98 operating system, a Millenium™ operating system, a Windows NT™ operating system, a Windows™ 2000 operating system, a Windows XP™ operating system, a Windows CE™ operating system, a PalmOS™ operating system, a Unix™ operating system, a Linux™ operating system, a Solaris™ operating system, an OS/2™ operating system, a BeOS™ operating system, a MacOS™ operating system, a VAX VMS operating system, or other operating system or platform. Client stations 310 may include a microprocessor such as an Intel x86-based or Advanced Micro Devices x86-compatible device, a Motorola 68K or PowerPC™ device, a MIPS device, Hewlett-Packard Precision™ device, or a Digital Equipment Corp. Alpha RISC processor, a microcontroller or other general or special purpose device operating under programmed control. Client stations 310 may further include an electronic memory such as a random access memory (RAM ) or electronically programmable read only memory (EPROM), a storage such as a hard drive, a CDROM or a rewritable CDROM or another magnetic, optical or other media, and other associated components connected over an electronic bus, as will be appreciated by persons skilled in the art. Client stations 310 may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). Client stations 10 may also include a network-enabled appliance such as a WebTV™ unit, a radio-enabled Palm™ Pilot or similar unit, a set-top box, a networkable game-playing console such as a Sony Playstation™, Sega™ Dreamcast™ or a Microsoft™ XBox™, a browser-equipped or other network-enabled cellular telephone, or another TCP/IP client or other device.

As shown in FIG. 3, client stations 310 are connected to a communications link 320. The communications link 320 may be, include or interface to any one or more of, for instance, the Internet, an intranet, a Personal Area Network (PAN), a Local Area Network (LAN), a Wide Area Network (WAN) or a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, V.34 or V.34bis analog modem connection, a cable modem, an Asynchronous Transfer Mode (ATM) connection, or a Fiber Distributed Data Interface (FDDI) or Copper Distributed Data Interface (CDDI) connection. The communications link 320 may further include or interface to any one or more of a Wireless Application Protocol (WAP) link, a General Packet Radio Service (GPRS) link, a Global System for Mobile Communication (GSM) link, a Code Division Multiple Access (CDMA) or Time Division Multiple Access (TDMA) link such as a cellular phone channel, a Global Positioning System (GPS) link, cellular digital packet data (CDPD), a Research in Motion, Limited (RIM) duplex paging type device, a Bluetooth, BlueTeeth or WhiteTooth radio link, or an IEEE 802.11 (Wi-Fi)-based radio frequency link. The communications link 320 may further include or interface to any one or more of an RS-232 serial connection, an IEEE-1394 (Firewire) connection, a Fibre Channel connection, an infrared (IDA) port, a Small Computer Systems Interface (SCSI) connection, a Universal Serial Bus (USB) connection or another wired or wireless, digital or analog interface or connection.

Also connected to the communications link 320, and thereby accessible to departments or units using stations 310, is a server station 330. The server station 330 may host one or more applications or modules that function to permit interaction between the compliance office, for example, and the individual departments or units as it relates to the compliance survey or series of questions. For example, the server station 330 may include an administration module that serves to permit interaction between the system and the compliance office charged with conducting the survey. Another module that may be hosted by server 330 is a query module that, among other things, presents the individual departments or units with questions comprising the survey. In one embodiment, the survey or questions are standard and presented to all departments or units. In another embodiment, the survey or questions may be personalized based on the department or unit to which they are presented. Also, a prioritization module may be provided to process the department or unit responses and determine a ranking of various business areas and categories based on comparative risk severity. Other functional modules may be provided. The server station 330 may include, for instance, a workstation running the Microsoft Windows™NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

A representative of a department or unit may access the server station 330 via the communications link 320 using a client station 310. As was mentioned above, interaction between the system 300 of the invention and each department or unit permits the direct answering of questions relating to compliance of laws or regulations affecting various business areas. Specifically, the department or units may input their answers to the questions using an input device (not shown) associated with station 310, which input device may comprise a keyboard, mouse, joystick, or other like device. The nature of the questions presented may, in one embodiment, vary depending on the identity of the department or unit. In such an embodiment, each department or unit will only be presented with questions relating to business areas or categories which the department or unit's work impacts. For example, the manufacturing unit of a corporation may be presented with questions relating to manufacturing, but not questions relating to research and development, or advertising and marketing regulations, for example. Identification of a department or unit may be determined automatically by the system 300 based on the department or unit's IP address or other similar identifier, or may be based on log-in data or information provided by the representative of the department or unit, such as the department or unit's predetermined user name and a password. Other information may be used to personalize the session. In another embodiment, the same questions are presented to all participating departments or units.

Information relied on by the system 300 may be stored in a database 340, as shown in FIG. 3. The database 340 may include or interface to, for example, an Oracle™ relational database sold commercially by Oracle Corporation. Other databases, such as an Informix™ database, Database 2 (DB2) database, a Sybase™ database or another data storage or query format, platform or resource such as an On Line Analytical Processing (OLAP) data storage facility, a Standard Query Language (SQL) data storage facility, a storage area network (SAN) facility, or a Microsoft Access™ database or other similar database platform or resource. The database 340 may be supported by a server or other resources, and may include redundancy, such as a redundant array of independent disks (RAID), for data protection. For example, the database 340 and the server station 330 may comprise an OLAP system that generates a plurality of user-specific reports from data maintained by the database 340. In another example, the server station 330 may be associated with or connected to a database server (not shown) that serves to present queries against the database 340. The database server may comprise an OLAP server system for accessing and managing data stored in the database 340. The database server may also comprise a Relational On Line Analytical Processing (ROLAP) engine, a Multi-dimensional On Line Analytical Processing (MOLAP) engine, or a Hybrid On Line Analytical Processing (HOLAP) engine according to different embodiments. Specifically, the database server may comprise a multithreaded server for performing analyses directly against the database 340.

Information stored in the database 340 may be input and administered by a representative of the compliance office, for example, via an administration interface 350. Information entered by the representative may, in one example, correspond to the specific questions that will be presented to the various departments or units relating to compliance matters involving various business areas or categories. In addition, the representative may input the various indices and formulas relevant to the prioritization process of the invention. For instance, the representative may input the corresponding occurrence and severity risk indices that may be used to weigh the responses of the individual departments or units. The representative may, for example, input the parameters of the possible answers to the questions presented, such as, “0” for N/A, “1” for Yes, no further work is needed, “2” for Yes, some improvement is needed to get to the level the compliance office wants, “3” for No, almost to yes, “4” for No, sometimes, and “5” No, seldom or never. Other levels or distinctions are contemplated and possible. Likewise, the representative of the compliance office may input the different levels associated with the occurrence index, as well as the formula and levels used in determining or calculating the appropriate detection indices. For example, the representative may input, in relation to the occurrence index, that “0” corresponds to N/A, “1” to <10,001 employees (or policies), “2” to 10,000-100,001 employees (or policies), “3” to >100,001 employees (or policies), etc. Further, the representative may also use administration module 250 to input identification information of the individual departments or units, such as, for example, the IP address corresponding to each department, or username and password information. The identification information may be used by the compliance office to personalize the survey or series of questions based on the identity of the receiving department or unit. Other information may be entered. In all instances, the inputted information may be stored and updated, as necessary.

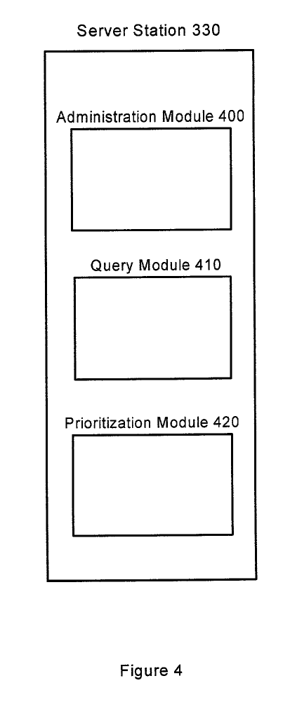

The server station 330 is shown in more detail in FIG. 4. As shown, the server station 330 may include an administration module 400 that may be accessed by the compliance office via the administration interface 350 to monitor or control operation of the system 300, create, input or update information stored in the database 340, such as information regarding the departments or units being questioned. Other information may be administered or inputted. For example, the administration module 400 may query a representative of the insurance company, via an interface, to input information regarding a department or unit, such as identification information, the particular business areas or categories relevant to that particular department or unit, and any other relevant information. The administration module 400 may also be used by a representative of the insurance company to monitor of the system 100's overall operation. For instance, the insurance company may monitor department or unit participation, as well as track department or unit responses.

The server station 30 may also include a query module 410 for entering, organizing and editing the questions to be presented to the various departments or units. By way of example, a representative of the compliance office may access query module 410, via interface 350, and specifically draft and revise the questions to be presented to the departments or units as part of the survey. Further, the representative may use query module 410 to categorize or associate individual questions with one or more business areas or categories. For instance, certain questions may be presented in connection with the product design category of the Product Development area, while others may be presented in connection with all categories of Product Development. Query module 410 may thus be used to correlate the individual questions with corresponding business areas and categories. Similarly, query module 410 may also be used to co-relate questions with individual departments or units. Specifically, query module 410 may be used by the compliance office to designate which questions, business areas, or categories should be presented to which departments or units. Query module 410 may also be used to automatically identify the department or unit based, in one embodiment, on the user's IP address. In another embodiment, the query module 410 determines the user's identity based on log-in information provided by the user, such as the user's username and password, and accesses information stored in the database 40 relating to the identified user. In either case, the information stored in the database 440 may be used to personalize the survey or series of questions presented.

Query module 410 may also be accessed by each department or unit being surveyed via stations 310. In one embodiment, query module 410 may present each department or unit with a graphics interface presenting each question to be answered. The interface may include a space wherein the department or unit is to designate its response to the question. In another embodiment, the questions may be presented in a spreadsheet file which, in one embodiment, may be transmitted to the department or units by query module 410. In this embodiment, the department may respond to the individual questions presented and transmit the completed spreadsheet file back to query module 410. Transmittal between the server 330 and stations 310 may occur using electronic mail or other file transfer protocol.

Server 330 may also include a prioritization module 420 that serves to prioritize or rank the business areas or categories based on the severity risk of non-compliance. In one embodiment, severity risk is determined by the responses provided by the departments or units to the questions presented, and by a severity risk index that, in one embodiment, may be selected by the compliance office. In another embodiment, the prioritization module determines or calculates a detection index that, as discussed above, is based on the responses of the departments or units, the number of questions, and the number of participating departments or units. In another embodiment, prioritization module 420 may be used to select an occurrence index indicating the potential consequences of non-compliance. In yet another embodiment, the prioritization module may also be used to calculate a total risk score for each category for which questions were presented. For example, prioritization module 420 may be calculate the product of the detection, occurrence, and severity risk indices. In one embodiment, the occurrence and severity risk indices are selected by the compliance office for each category. The information needed for this calculation may be obtained by prioritization module 420 by accessing database 340.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A method for use in compliance management, comprising:
presenting, via a computer network, at least one user with a series of questions relating to at least one business category;
soliciting, via the computer network, a response from the at least one user for each question presented; and
prioritizing, via the computer network, the at least one business category based on the at least one user's responses and at least one standard severity risk index.

2. The method of claim 1 wherein the user response comprises a “Yes” or “No.

3. The method of claim 1 wherein at the least one standard severity risk index comprises a number between 1 and 10 corresponding to a specific level of risk.

4. The method of claim 3 wherein the number “1” comprises the lowest level of risk severity, and the number “10” the highest level of severity.

5. The method of claim 1 wherein the at least one standard severity risk index corresponds to the at least one business category.

6. The method of claim 1 further comprising the step of determining a detection index based on the number of questions presented, the at least one user's responses, and the number of users.

7. The method of claim 6 further comprising determining an occurrence index based on the potential consequences of non-compliance.

8. The method of claim 7 wherein the prioritizing step comprises determining at least one total risk score based on the detection, occurrence, and severity risk indices.

9. The method of claim 8 further comprising ranking the at least one business category based on the at least one total risk score.

10. A system for use in compliance management, comprising:
a query module associated with an engine for presenting at least one user with a series of questions relating to at least one business category, and for soliciting and receiving responses from the at least one user for each question presented;
a prioritization module associated with the engine for prioritizing the at least one business category based on the at least one user's responses and at least one standard severity risk index.

11. The system of claim 10 wherein the series of questions are presented to the user over a communications network.

12. The system of claim 10 further comprising an administration module associated with the engine for inputting, updating and accessing data associated with the query and prioritization modules, the administration module being accessible to an administrator of the system via an administration interface.

13. The system of claim 10 wherein the user response comprises a “Yes” or “No” response.

14. The system of claim 10 wherein the at least one standard severity risk index comprises a number between 1 and 10 corresponding to a specific level of risk.

15. The system of claim 14 wherein the number “1” comprises the lowest level of severity, and the number “10” the highest level of severity.

16. The system of claim 10 wherein the at least one standard severity risk index corresponds to the at least one business category.

17. The system of claim 10 wherein the prioritization module further determines a detection index based on the number of questions presented, the at least one user's responses, and the number of users.

18. The system of claim 17 wherein the prioritization module further determines an occurrence index based on the potential consequences of non-compliance.

19. The system of claim 18 wherein the prioritization module further determines at least one total risk score based on the detection, occurrence, and severity risk indices.

20. The system of claim 19 wherein prioritization module further ranks the at least one business category based on the at least one total risk score.
